(19) United States
(12) Patent Application Publication
(10) Pub. No.: US 2014/0160026 A1
(43) Pub. Date: Jun. 12, 2014

(54) ABBREVIATED KEYBOARDS FOR MOBILE PASSWORD ENTRY

(71) Applicant: INTERNATIONAL BUSINESS MACHINES CORPORATION, Armonk, NY (US)

(72) Inventors: Erik J. Burckart, Raleigh, NC (US); Andrew J. Ivory, Wake Forest, NC (US); Aaron K. Shook, Raleigh, NC (US); David M. Stecher, Durham, NC (US)

(73) Assignee: INTERNATIONAL BUSINESS MACHINES CORPORATION, Armonk, NY (US)

(21) Appl. No.: 13/709,265

(22) Filed: Dec. 10, 2012

(51) Int. Cl. G06F 3/02

(52) U.S. Cl. CPC G06F 3/02
USPC 345/168

(57) ABSTRACT

A computer implemented method is provided for receiving a password from a mobile device. A login initiation is received from a touch screen enabled mobile device to a password-protected service. The mobile device comprises a default keyboard including a set of alphanumeric or symbol characters. Responsive to initiating the login initiation, a customized shortened keyboard is retrieved. The customized shortened keyboard comprises a subset of the set of alphanumeric or symbol characters. The subset comprises alphanumeric or symbol characters within a password, and extraneous alphanumeric or symbol characters, but not the entirety of the set of alphanumeric or symbol characters. The customized shortened keyboard is returned to the mobile device. The password is received from the mobile device. The customized shortened keyboard is used to enter the password into the mobile device. The password is then validated.

### BACKGROUND

1. Field

The disclosure relates generally to a computer implemented method, a computer, and a computer program product for receiving passwords on a mobile device. More specifically, the disclosure relates to a computer implemented method, a computer, and a computer program product for generating and displaying customized shortened keyboards for receiving passwords on a mobile device.

2. Description of the Related Art

Password requirements continue to get more complex on a daily basis. Today, most passwords require at least one upper case letter, at least one special character, and at least one number. Entering passwords like these can become very tedious on smartphones since they require pushing keys that toggle between alphanumeric and symbol characters and multiple sets of symbols on the keyboard. For example, on many popular mobile phones, entering such a password can require up to three screens to be toggled: one for alpha characters, one for numeric and some special characters, and another for other special characters that are not included with the numeric characters. This approach can be both tedious and error-prone for the user since it's very easy to make a mistake entering the password when you have to toggle between so many screens.

### SUMMARY

According to one embodiment of the present invention, a computer implemented method is provided for receiving a password from a mobile device. A login initiation is received from a touch screen enabled mobile device to a password-protected service. The mobile device comprises a default keyboard including a set of alphanumeric or symbol characters. Responsive to initiating the login initiation, a customized shortened keyboard is retrieved. The customized shortened keyboard comprises a subset of the set of alphanumeric or symbol characters. The subset comprises alphanumeric or symbol characters within a password, and extraneous alphanumeric or symbol characters, but not the entirety of the set of alphanumeric or symbol characters. The customized shortened keyboard is returned to the mobile device. The password is received from the mobile device. The customized shortened keyboard is used to enter the password into the mobile device. The password is then validated.

According to another embodiment of the present invention, a computer is provided for receiving a password from a mobile device. A login initiation is received from a touch screen enabled mobile device to a password-protected service. The mobile device comprises a default keyboard including a set of alphanumeric or symbol characters. Responsive to initiating the login initiation, a customized shortened keyboard is retrieved. The customized shortened keyboard comprises a subset of the set of alphanumeric or symbol characters. The subset comprises alphanumeric or symbol characters within a password, and extraneous alphanumeric or symbol characters, but not the entirety of the set of alphanumeric or symbol characters. The customized shortened keyboard is returned to the mobile device. The password is received from the mobile device. The customized shortened keyboard is used to enter the password into the mobile device. The password is then validated.

According to still another embodiment of the present invention, a computer readable storage medium is provided for receiving a password from a mobile device. The computer readable storage medium comprises instructions for receiving a login initiation from a touch screen enabled mobile device to a password-protected service. The mobile device comprises a default keyboard including a set of alphanumeric or symbol characters. The computer readable storage medium comprises instructions, responsive to initiating the login initiation, for retrieving a customized shortened keyboard. The customized shortened keyboard comprises a subset of the set of alphanumeric or symbol characters. The subset comprises alphanumeric or symbol characters within a password, and extraneous alphanumeric or symbol characters, but not the entirety of the set of alphanumeric or symbol characters. The computer readable storage medium comprises instructions for returning the customized shortened keyboard to the mobile device. The computer readable storage medium comprises instructions for receiving the password from the mobile device. The customized shortened keyboard is used to enter the password into the mobile device. The computer readable storage medium comprises instructions for validating the password.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is an illustration of a data processing system depicted in accordance with an illustrative embodiment;

FIG. 3 is a diagram of a client in the form of a mobile device depicted in accordance with a preferred embodiment of the present invention;

FIG. 4 is a block diagram of a mobile device shown in accordance with a preferred embodiment of the present invention;

FIG. 5 is a series of keyboards for entering data on a touchscreen display shown according to an illustrative embodiment;

FIG. 6 is a data flow for entering data on a touchscreen display shown according to an illustrative embodiment;

FIG. 7 is a custom keyboard shown according to an illustrative embodiment;

FIG. 8 is a flowchart of a registration process shown according to an illustrative embodiment; and

FIG. 9 is a process for authenticating a user shown according to an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

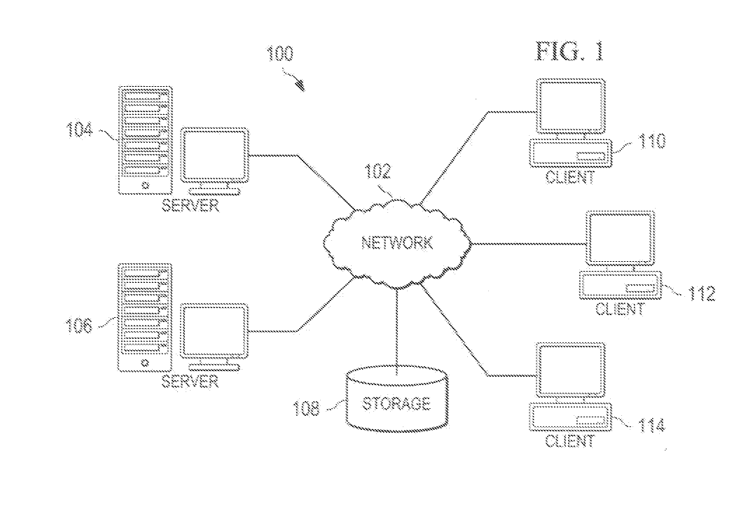

With reference now to the Figures and, in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

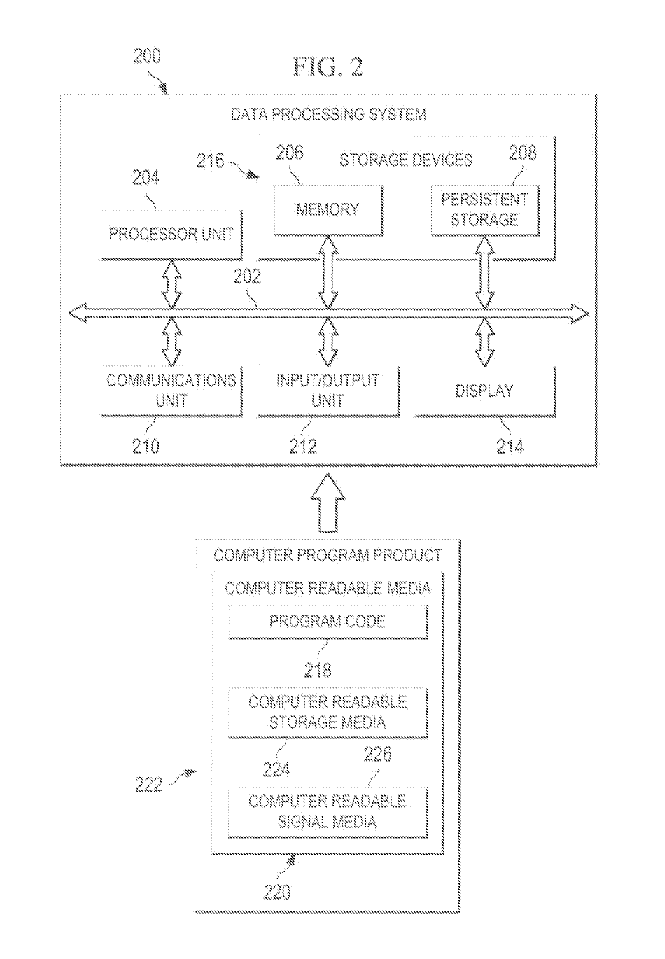

Turning now to FIG. 2, an illustration of a data processing system is depicted in accordance with an illustrative embodiment. Data processing system 200 may be a server computer such as server computer 104 and server computer 106 of FIG. 1. Data processing system 200 may also be a client computer, such as client computers 110, 112, and 114 of FIG. 1. In this illustrative example, data processing system 200 includes communications framework 202, which provides communications between processor unit 204, memory 206, persistent storage 208, communications unit 210, input/output unit 212, and display 214. In these examples, communications frame work 202 may be a bus system.

Processor unit 204 serves to execute instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Storage devices 216 may also be referred to as computer readable storage devices in these examples. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications framework 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200. In these examples, computer readable storage media 224 is a physical or tangible storage device used to store program code 218 rather than a medium that propagates or transmits program code 218. Computer readable storage media 224 is also referred to as a computer readable tangible storage device or a computer readable physical storage device. In other words, computer readable storage media 224 is a media that can be touched by a person.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 204 may take the form of a hardware unit that has circuits that are manufactured or configured for a particular use. This type of hardware may perform operations without needing program code to be loaded into a memory from a storage device to be configured to perform the operations.

For example, when processor unit 204 takes the form of a hardware unit, processor unit 204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 218 may be omitted because the processes for the different embodiments are implemented in a hardware unit.

In still another illustrative example, processor unit 204 may be implemented using a combination of processors found in computers and hardware units. Processor unit 204 may have a number of hardware units and a number of processors that are configured to run program code 218. With this depicted example, some of the processes may be implemented in the number of hardware units, while other processes may be implemented in the number of processors.

In another example, a bus system may be used to implement communications framework 202 and may be comprised of one or more buses, such as a system bus or an input/output bus. Of course, the bus system may be implemented using any suitable type of architecture that provides for a transfer of data between different components or devices attached to the bus system.

Additionally, a communications unit may include a number of more devices that transmit data, receive data, or transmit and receive data. A communications unit may be, for example, a modem or a network adapter, two network adapters, or some combination thereof. Further, a memory may be, for example, memory 206, or a cache, such as found in an interface and memory controller hub that may be present in communications framework 202.

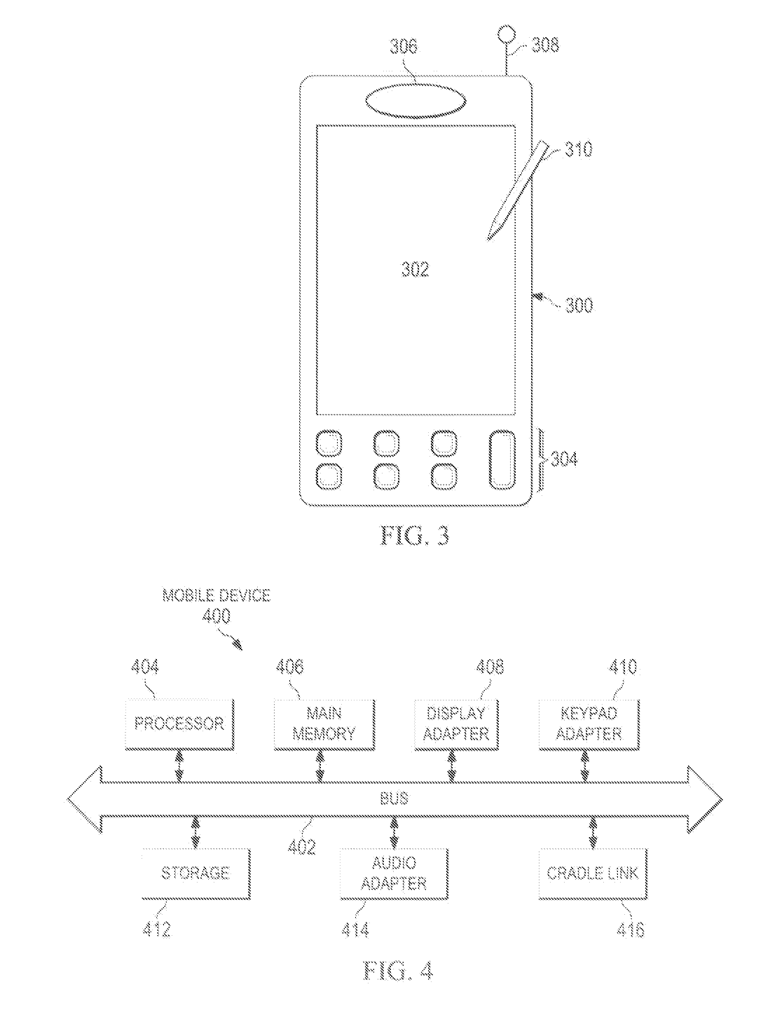

With reference now to FIG. 3, a diagram of a client in the form of a mobile device is depicted in accordance with a preferred embodiment of the present invention. Mobile device 300 includes a display 302 for presenting textual and graphical information. Display 302 may be a known display device, such as a liquid crystal display (LCD) device. The display may be used to present a map or directions, calendar information, a telephone directory, or an electronic mail message. In these examples, display 302 may receive user input using an input device such as, for example, stylus 310.

Mobile device 300 may also include keypad 304, speaker 306, and antenna 308. Keypad 304 may be used to receive user input in addition to using display 302. Speaker 306 provides a mechanism for audio output, such as presentation of an audio file. Antenna 308 provides a mechanism used in establishing a wireless communications link between mobile device 300 and a network, such as communications framework 202 in FIG. 2.

Mobile device 300 also preferably includes a graphical user interface that may be implemented by means of systems software residing in computer readable media in operation within mobile device 300.

Turning now to FIG. 4, a block diagram of a mobile device is shown in accordance with a preferred embodiment of the present invention. Mobile device 400 is an example of a mobile device, such as mobile device 300 in FIG. 3, in which code or instructions implementing the processes of the present invention may be located. Mobile device 400 includes a bus 402 to which processor 404 and main memory 406 are connected. Display adapter 408, keypad adapter 410, storage 412, and audio adapter 414 also are connected to bus 402. Cradle link 416 provides a mechanism to connect mobile device 400 to a cradle used in synchronizing data in mobile device 400 with another data processing system. Further, display adapter 408 also includes a mechanism to receive user input from a stylus when a touch screen display is employed.

An operating system runs on processor 404 and is used to coordinate and provide control of various components within mobile device 400 in FIG. 4. The operating system may be, for example, a commercially available operating system such as Windows CE, which is available from Microsoft Corporation. Instructions for the operating system and applications or programs are located on storage devices, such as storage 412, and may be loaded into main memory 406 for execution by processor 404.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4.

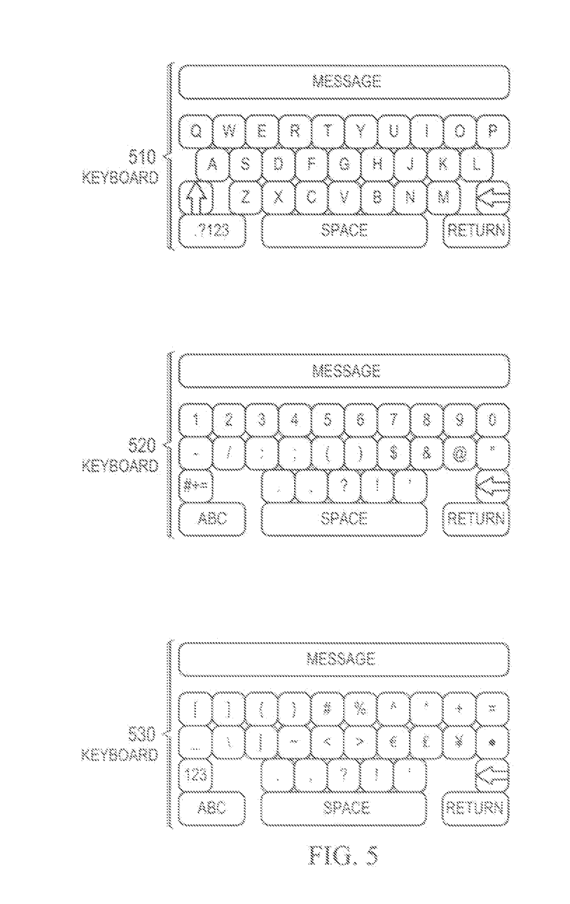

Referring now to FIG. 5, a series of keyboards for entering data on a touchscreen display is shown according to an illustrative embodiment. The keyboards 510, 520, and 530 can be displayed to a mobile device, such as mobile device 300 of FIG. 3. A user is able to toggle between keyboards 510, 520, and 530 pressing various keys of the keyboard.

In the illustrative example, a user desires to enter the password, “G3n3r1c P@$$w0rd”. The user's desired password has 15 alphanumeric or symbol characters. However to enter the user's desired password utilizing keyboards 510, 520, and 530, the user must make 30 separate keystrokes.

To enter the character “G”, the user must first toggle on the capitalization key. Then, the user can enter the character “G”. The character “G” therefore requires two separate keystrokes.

To enter the character “3”, the user must first toggle from keyboard 510 to keyboard 520. Then, the user can enter the character “3”. The character “3” therefore requires two additional keystrokes.

To enter the character “n”, the user must first toggle back from keyboard 520 to keyboard 510. The user can then enter the character “n”. The character “n” therefore requires two additional keystrokes.

To enter the character “3”, the user must first toggle from keyboard 510 to keyboard 520. Then, the user can enter the character “3”. The character “3” therefore requires two additional keystrokes.

To enter the character “r”, the user must first toggle back from keyboard 520 to keyboard 510. The user can then enter the character “r”. The character “r” therefore requires two additional keystrokes.

To enter the character “1”, the user must first toggle from keyboard 510 to keyboard 520. Then, the user can enter the character “1”. The character “1” therefore requires two additional keystrokes.

To enter the character “c”, the user must first toggle back from keyboard 520 to keyboard 510. The user can then enter the character “c”. The character “c” therefore requires two additional keystrokes.

The user then pushes the spacebar. To enter the character “P”, the user must first toggle on the capitalization key. Then, the user can enter the character “P”. The character “P” therefore requires three additional keystrokes.

To enter the character “@”, the user must first toggle from keyboard 510 to keyboard 520. Then, the user can enter the character “@”. The character “@” therefore requires two additional keystrokes.

The user can enter the characters “$$” without toggling away from keyboard 520. The characters “$$” therefore requires two additional keystrokes.

To enter the character “w”, the user must first toggle back from keyboard 520 to keyboard 510. The user can then enter the character “w”. The character “w” therefore requires two additional keystrokes.

To enter the character “0”, the user must first toggle from keyboard 510 to keyboard 520. Then, the user can enter the character “0”. The character “0” therefore requires two additional keystrokes.

To enter the character “r”, the user must first toggle back from keyboard 520 keyboard 510. The user can then enter the character “r”. The character “r” therefore requires two additional keystrokes.

The user can enter the character “d” without toggling away from keyboard 510. The character “d” therefore requires one additional keystroke.

Therefore, a user desiring to enter the password, “G3n3r1c P@$$w0rd” must make a total of 30 keystrokes. The user must toggle between keyboard 510 and keyboard 520 ten separate times.

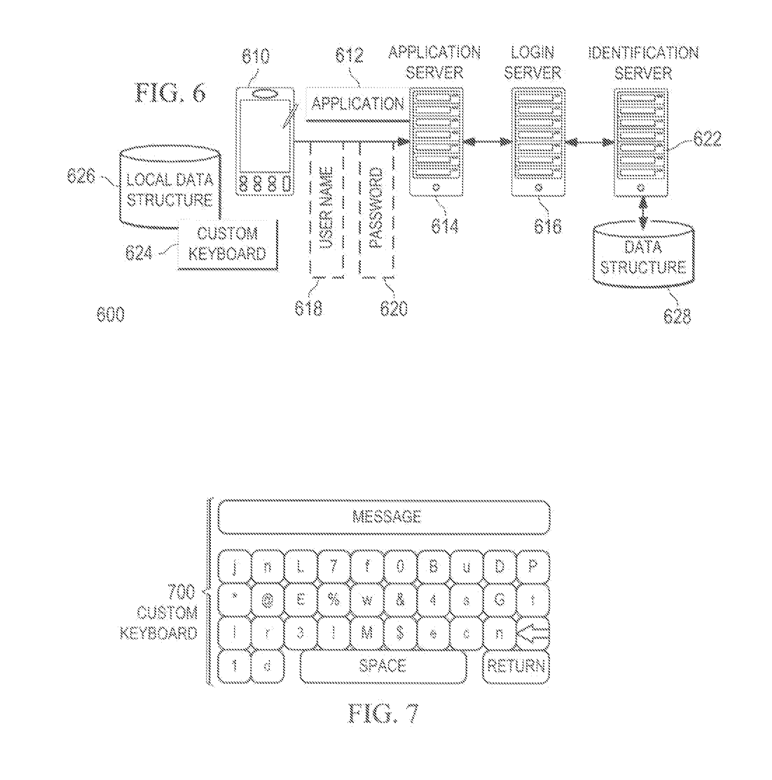

Referring now to FIG. 6, a data flow for entering data on a touchscreen display is shown according to an illustrative embodiment. Data flow 600 can execute on one or more computer systems, such as client computers 110, 112, and 114 and server computer 104 of FIG. 1.

Mobile device 610 is mobile device 300 of FIG. 3.

The user of mobile device 610 can access application 612 located on application server 614.

To utilize application 612, mobile device 610 must login to application server 614 by utilizing login server 616.

When the user wants to utilize application 612 for a first time, login server 616 prompts the user to enter a username and password for registration. The user then enters user name 618 and password 620 into mobile devices for transmission to login server 616. The user can enter username 618 and password 620 utilizing a series of keywords, such as keyboards 510, 520, and 530 of FIG. 5. After registering, the user can utilize application 612.

Login server 616 forwards username 618 and password 620 to identification server 622.

In one illustrative embodiment, responsive to registration, mobile device 610 generates custom keyboard 624. Unlike keyboards 510, 520, and 530 of FIG. 5, custom keyboard 624 is generated by mobile device 610 to contain each character within password 620 within a single keyboard, such that the user does not need to toggle through multiple keyboards to enter password 620. Alphanumeric or symbol characters in custom keyboard 624 include each alphanumeric or symbol character in password 620, as well as extraneous alphanumeric or symbol characters. The characters can be arranged randomly within custom keyboard 624. That is, custom keyboard 624 does not follow a standard keyboard layout, such as a QWERTY keyboard layout or a Dvorak keyboard layout.

In one illustrative embodiment, the alphanumeric or symbol characters with getting custom keyboard 624 are static. That is, while the location of the numeric characters within custom keyboard 624 may be random, the same alphanumeric or symbol characters are presented each time custom keyboard 624 is utilized. In this manner, alphanumeric or symbol characters in password 620 cannot be determined, and extraneous characters cannot be eliminated, through an elimination process of continuously reloading custom keyboard 624 in viewing random characters therein.

Mobile device 610 can associate custom keyboard 624 with login server 616 in local data structure 626.

Upon subsequently utilizing to login server 616, mobile device 610 retreats custom keyboard 624 from local data structure 626. The user can enter password 620 utilizing custom keyboard 624, without toggling through multiple keyboards.

In one illustrative embodiment, custom keyboard 624 can be generated by identification server 622. Identification server 622 associates mobile device 610 with custom keyboard 624 in data structure 628. Custom keyboard 624 can then be retrieved from identification server 622 and forwarded to mobile device 610 to allow the user to utilize custom keyboard 624 when logging into login server 616.

Referring now to FIG. 7, a custom keyboard is shown according to an illustrative embodiment. Custom keyboard 700 is custom keyboard 624 of FIG. 6.

In the illustrative example, a user desires to enter the password, “G3n3r1c P@$$w0rd”. The user's desired password has 15 alphanumeric or symbol characters. Utilizing custom keyboard 700, the user makes only one keystroke for each of the alphanumeric or symbol characters, for total of 15 keystrokes.

Custom keyboard 700 includes alphanumeric or symbol characters included in the password, “G3n3r1c P@$$w0rd”. Custom keyboard 700 also includes extraneous alphanumeric or symbol characters not included in the password, “G3n3r1c P@$$w0rd”. Alphanumeric or symbol characters included in the password, “G3n3r1c P@$$w0rd” along with extraneous alphanumeric or symbol characters can be arranged randomly within custom keyboard 700.

In one illustrative embodiment, the alphanumeric or symbol characters with getting custom keyboard 700 are static. That is, while the location of the numeric characters within custom keyboard 700 may be random, the same alphanumeric or symbol characters are presented each time custom keyboard 700 is utilized. In this manner, alphanumeric or symbol characters in custom keyboard 700 cannot be determined, and extraneous characters cannot be eliminated, through an elimination process of continuously reloading custom keyboard 700 in viewing random characters therein.

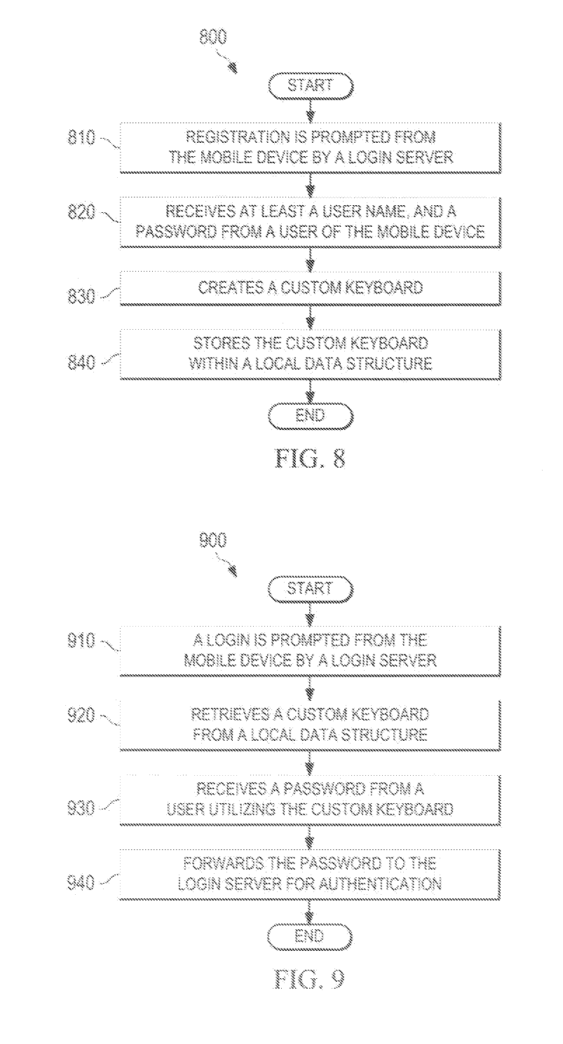

Referring now to FIG. 8, a flowchart of a registration process is shown according to an illustrative embodiment. Process 800 is a software process executing on a mobile device, such as mobile device 300 of FIG. 3.

Process 800 begins when a registration is prompted from the mobile device by a login server (step 810). The login server can be, for example but not limited to, login server 616 of FIG. 6.

Responsive to being prompted for registration, process 800 receives at least a user name, and a password from a user of the mobile device (step 820). The username can be, for example but not limited to, username 618 of FIG. 6. The password can be, for example but not limited to, password 620 of FIG. 6.

Responsive to receiving the password, process 800 creates a custom keyboard (step 830). The custom keyboard can be, for example custom keyboard 524 of FIG. 5.

Responsive to creating the custom keyboard, process 800 stores the custom keyboard within a local data structure (step 840), with the process terminating thereafter. The local data structure can be, for example but not limited to local data structure 626 of FIG. 6.

Referring now to FIG. 9, a process for authenticating a user is shown according to an illustrative embodiment. Process 900 is a software process executing on a mobile device, such as mobile device 300 of FIG. 3.

Process 900 begins when a login is prompted from the mobile device by a login server (step 910). The login server can be, for example but not limited to login server 616 of FIG. 6.

Responsive to the prompt for login, process 900 retrieves a custom keyboard from a local data structure (step 920). The custom keyboard can be, for example but not limited to custom keyboard 624 of FIG. 6. The local data structure can be, but not limited to, local data structure 626 of FIG. 6.

Process 900 receives a password from a user utilizing the custom keyboard (step 930). Process 900 forwards the password to the login server for authentication (step 940), with the process terminating thereafter.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block might occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for receiving a password from a mobile device, the method comprising:
receiving a login initiation from a touch screen enabled mobile device to a password-protected service, wherein the mobile device comprises a default keyboard including a set of alphanumeric and symbol characters;
responsive to initiating the login initiation, retrieving a customized shortened keyboard, the customized shortened keyboard comprising a subset of the set of alphanumeric and symbol characters, the subset comprising alphanumeric and symbol characters within the password, and extraneous alphanumeric and symbol characters but not an entirety of the set of alphanumeric and symbol characters;
returning the customized shortened keyboard to the mobile device;
receiving the password from the mobile device, wherein the customized shortened keyboard is used to enter the password into the mobile device; and
validating the password.

2. The computer implemented method of claim 1, further comprising:
responsive to initiating the login initiation, retrieving the customized shortened keyboard, wherein the customized shortened keyboard is retrieved from a local data structure with in the mobile device.

3. The computer implemented method of claim 1, further comprising:
responsive to initiating the login initiation, retrieving the customized shortened keyboard, wherein the customized shortened keyboard is retrieved from an identification server.

4. The computer implemented method of claim 1, further comprising:
displaying the customized shortened keyboard on the mobile device, wherein the subset of the set of alphanumeric and symbol characters are randomly positioned within the customized shortened keyboard.

5. The computer implemented method of claim 1, further comprising:
displaying the customized shortened keyboard on the mobile device, wherein the subset of the set of alphanumeric and symbol characters are staticly positioned within the customized shortened keyboard.

6. The computer implemented method of claim 1, wherein the subset of the set of alphanumeric and symbol characters is a static subset that does not change on subsequent views of the customized shortened keyboard.

7. The computer implemented method of claim 1, wherein the customized shortened keyboard does not follow a QWERTY keyboard layout or a Dvorak keyboard layout.

8. A computer comprising:
a memory, the memory containing computer usable program code for receiving a password;
a bus connecting the memory to a processor;
the processor, wherein the processor executes the computer usable program code to receive a login initiation from a touch screen enabled mobile device to a password-protected service, wherein the mobile device comprises a default keyboard including a set of alphanumeric and symbol characters;
responsive to initiating the login initiation, to retrieve a customized shortened keyboard, the customized shortened keyboard comprising a subset of the set of alphanumeric and symbol characters, the subset comprising alphanumeric and symbol characters within the password, and extraneous alphanumeric and symbol characters but not an entirety of the set of alphanumeric and symbol characters; and
to return the customized shortened keyboard to the mobile device; to receive the password from the mobile device, wherein the customized shortened keyboard is used to enter the password into the mobile device; and to validate the password.

9. The computer of claim 8, wherein the processor further executes the computer usable program code:
responsive to initiating the login initiation, to retrieve the customized shortened keyboard, wherein the customized shortened keyboard is retrieved from a local data structure with in the mobile device.

10. The computer of claim 8, wherein the processor further executes the computer usable program code:
responsive to initiating the login initiation, to retrieve the customized shortened keyboard, wherein the customized shortened keyboard is retrieved from an identification server.

11. The computer of claim 8, wherein the processor further executes the computer usable program code:
to display the customized shortened keyboard on the mobile device, wherein the subset of the set of alphanumeric and symbol characters are randomly positioned within the customized shortened keyboard.

12. The computer of claim 8, wherein the processor further executes the computer usable program code:
to display the customized shortened keyboard on the mobile device, wherein the subset of the set of alphanumeric and symbol characters are staticly positioned within the customized shortened keyboard.

13. The computer of claim 8, wherein the subset of the set of alphanumeric and symbol characters is a static subset that does not change on subsequent views of the customized shortened keyboard.

14. The computer of claim 8, wherein the customized shortened keyboard does not follow a QWERTY keyboard layout or a Dvorak keyboard layout.

15. A computer readable storage medium having computer usable instructions encoded thereon for receiving a password, the computer usable instructions comprising:
instructions for receiving a login initiation from a touch screen enabled mobile device to a password-protected service, wherein the mobile device comprises a default keyboard including a set of alphanumeric and symbol characters;
instructions, responsive to initiating the login initiation, for retrieving a customized shortened keyboard, the customized shortened keyboard comprising a subset of the set of alphanumeric and symbol characters, the subset comprising alphanumeric and symbol characters within a password, and extraneous alphanumeric and symbol characters but not the entirety of the set of alphanumeric and symbol characters;
instructions for returning the customized shortened keyboard to the mobile device;
instructions for receiving the password from the mobile device, wherein the customized shortened keyboard is used to enter the password into the mobile device; and
instructions for validating the password.

16. The computer readable storage medium of claim 15, further comprising:
instructions responsive to initiating the login initiation, for retrieving the customized shortened keyboard, wherein the customized shortened keyboard is retrieved from a local data structure with in the mobile device.

17. The computer readable storage medium of claim 15, further comprising:
instructions responsive to initiating the login initiation, for retrieving the customized shortened keyboard, wherein the customized shortened keyboard is retrieved from an identification server.

18. The computer readable storage medium of claim 15, further comprising:
instructions for displaying the customized shortened keyboard on the mobile device, wherein the subset of the set of alphanumeric and symbol characters are randomly positioned within the customized shortened keyboard.

19. The computer readable storage medium of claim 15, further comprising:
instructions for displaying the customized shortened keyboard on the mobile device, wherein the subset of the set of alphanumeric and symbol characters are staticly positioned within the customized shortened keyboard.

20. The computer readable storage medium of claim 15, wherein the subset of the set of alphanumeric and symbol characters is a static subset that does not change on subsequent views of the customized shortened keyboard.

21. The computer readable storage medium of claim 15, wherein the customized shortened keyboard does not follow a QWERTY keyboard layout or a Dvorak keyboard layout.
